(19) United States
(12) Patent Application Publication
(10) Pub. No.: US 2026/0284859 A1
(43) Pub. Date: Sep. 24, 2026

(54) WALL SUPPORT RAIL AND TOOL HANGER APPARATUS AND RELATED METHODS

(71) Applicant: Katz-Moses Group, LLC, Santa Barbara, CA (US)

(72) Inventors: Jonathan Katz-Moses, Santa Barbara, CA (US); Holden Tranquillo, Shoreview, MN (US)

(73) Assignee: Katz-Moses Group, LLC, Santa Barbara, CA (US)

(21) Appl. No.: 19/086,738

(22) Filed: Mar. 21, 2025

(51) Int. Cl. B25H 3/04; F16M 13/02; H01F 7/02

(52) U.S. Cl. CPC B25H 3/04; F16M 13/02; F16M 2200/025; H01F 7/0252

(57) ABSTRACT

Tool mounting apparatus and methods that include a French cleat having an angled surface with an inverted T-slot extending from the angled surface, and a mounting bracket with a complementary angled mounting surface for engagement with the French cleat, in which the bracket has a through hole that aligns with the inverted T-slot. A locking pin may be inserted through the through hole and inverted T-slot, the pin having a shaft with a cap on one end, and an engagement surface at an opposite end. Rotation of the locking pin secures the mounting bracket by frictional contact between the engagement surface and the inverted T-slot. Embodiments may include a snap lock pin for cap retention, a spring-loaded mechanism, one or more detents for tactile feedback, and/or visual alignment indicators. The mounting bracket may be provided with a modular tool receiver, shelf, or other structure for supporting tools and equipment.

### FIELD OF THE INVENTION

The present invention relates generally to tool mounting systems, and more particularly to apparatus and methods for securely mounting tools, equipment, shelves or other items to a vertical surface using a rail attached to the surface and hangers for temporary secure engagement with the rail that employ an improved French cleat system with an enhanced locking mechanism.

### BACKGROUND OF THE INVENTION

Precision tools are essential in achieving accurate and consistent results across various industries such as aerospace, automotive, woodworking, and general machining. In these industries, tool mounting systems are commonly employed to organize, secure, and provide accessible storage for tools and equipment. One such system, known as a French cleat, is widely used for mounting tools, equipment, and storage units to vertical surfaces. Traditional French cleat systems rely on frictional engagement between a sloped cleat and a complementary mounting bracket. While effective for supporting various objects, these systems often lack a secure locking mechanism, making them susceptible to accidental disengagement or shifting during use.

Existing solutions that attempt to improve French cleat systems often require cumbersome adjustment mechanisms or additional hardware that compromises ease of use. Some systems rely on manual locking elements that are complex to engage or disengage, while others provide insufficient security to ensure stable positioning of mounted objects. These limitations are particularly problematic in applications where tools must remain securely fixed in a specific orientation to maintain accuracy, stability, and overall workspace organization.

To address these challenges, embodiments of the present invention provide an improved tool mounting system that incorporates a locking mechanism to enhance stability and security. By providing a T-slot in the French cleat of the wall rail, and providing an improved locking pin that engages with the T-slot, embodiments of the present invention ensure secure temporary positioning of a mounting bracket in a fixed orientation on a wall rail. These improved methods and apparatus provide reliable engagement, simplified operation, and enhanced versatility for supporting a variety of tools, equipment, and storage units.

### SUMMARY OF THE INVENTION

The present invention provides a tool mounting and storage system operable to temporarily securely attach mounting brackets to a French cleat of a wall rail in a fixed orientation. The system is well suited for securing tools, equipment, shelves or other items requiring a stable and repeatable mounting solution. Embodiments of the invention include a modified French cleat featuring a rail with an angled wedge surface and an inverted T-slot extending through the angled surface. The inverted T-slot may be configured to receive a locking pin that selectively engages with the inverted T-slot to secure a mounting bracket to the rail. Embodiments of the mounting bracket include a mounting surface that is angled to complement the wedge surface of the rail of the French cleat, ensuring stable engagement, and at least one through hole that aligns with the inverted T-slot on the rail for receiving the locking pin.

Embodiments of the locking pin may include a shaft having a head at a first proximal end of the shaft, and a specially shaped block structure at the opposite distal end of the shaft. Embodiments of the block structure include one or more flanges that extend out perpendicularly from one side or from opposite sides of the distal end of the shaft. In some embodiments, the flanges attached to the distal end of the shaft form an inverted T shape. The block structure with flanges may have a cross section that is the same as or more narrow than the cross section of the shaft to which it is attached. In embodiments of the invention, one or more through holes in the mounting bracket have a cross section that is sized and shaped to match that of the shaft and block structure, in the form of a modified key-hole, such that the shaft and block structure may only be received into or removed from the through hole when the block is properly oriented to align with the modified key-hole shape.

Embodiments of the head of the locking pin should be larger and/or wider than the cross section of the key-hole opening of the through hole so that the head cannot enter the through hole. In different embodiments, the head of the locking pin may be in the form of a tab, wing, knob or other suitable structure that may be easily hand-manipulated. In some embodiments, the tab or wing of the head may be aligned with the lower flange of the block, such that the position of the tab or wing indicates the position of the flange of the lower block. In some embodiments, a spring or other biasing device may be provided along the shaft adjacent to the head to urge the head of the locking pin away from the through hole of the mounting bracket.

In use, an embodiment of a wall rail having a modified French cleat with inverted T-slot is attached to a wall or other vertical surface. An angled surface of an embodiment of a mounting bracket having at least one through hole therein, the through hole having a modified key-hole shape, is brought against the complementary surface of the French cleat, such that the mounting bracket is supported by the French cleat, and the through hole is in communication with the inverted T-slot. An embodiment of a locking pin having a specially shaped block is oriented in order to be aligned with the modified key-hole, and then inserted into the through hole of the mounting bracket such that the block extends into the lower horizontal portion of the inverted T-slot. The head at the proximal end of the locking pin shaft is then turned (e.g., anywhere from 1 to 90 degrees) which rotates the block at the distal end of the shaft of the locking pin. This rotation takes the block out of alignment with the key-hole slot, preventing the locking pin from being removed from the through hole, with the block being frictionally engaged against one or more walls of the inverted T-slot. This friction temporarily secures the mounting bracket to the French cleat. Rotating the head such that the block is once again aligned with the key-hole slot of the through hole makes it possible to remove the locking pin, and thereafter remove the mounting bracket.

The locking pin may toggle efficiently between a locked and unlocked state. In the locked configuration, the block at the distal end of the locking pin presses against the inner wall of the inverted T-slot preventing removal movement or dislodgement of the pin. In the unlocked configuration, the locking pin is rotated so that the flanges of the block align with the key-hole slot of the through hole, allowing the pin to pass freely through the through hole for easy insertion or removal. This design offers both enhanced security and ease of use, making the system well-suited for applications requiring frequent mounting and dismounting of tools or equipment.

The components of the system may be constructed from a variety of durable materials depending on the intended application. Embodiments of the modified French cleat and mounting bracket may be manufactured from metals such as aluminum, steel, or stainless steel for high-load capacity applications. Alternatively, embodiments of the cleat and bracket may be made of wood, or molded from high-strength plastics or composites for lightweight or cost-effective solutions. Embodiments of the locking pin may be composed of metal for durability, or engineered plastics for corrosion resistance and improved flexibility.

In alternative embodiments, the mounting bracket may include various configurations to accommodate different tool receivers. Tool receivers may include shelves, cantilevered arms, integrated hooks for hanging hand tools, slotted brackets for holding power tools, adjustable arms designed to support bulkier equipment, and the like. Additionally, modular tool receiver configurations may be utilized, incorporating quick-swap features that allow users to interchange tool holders without disassembling the entire mounting system. Tool receivers may also include magnetic surfaces, rubberized pads for vibration isolation, or locking clamps for enhanced security when supporting valuable or heavy equipment.

Other embodiments of the invention may include multiple inverted T-slots along the French cleat to allow for adjustable positioning of multiple mounting brackets. In some embodiments, the locking pin may be adapted with features such as spring-loaded mechanisms for automatic engagement, cam-action elements for improved stability, and/or detent features that provide tactile feedback when the pin reaches a locked position. By way of example, and without limitation, when a spring is provided along the shaft adjacent to the head of the locking pin, when the head is turned such that the block is aligned with the key-hole slot, the spring will cause the locking pin to be urged out of the through hole; whereas, if the pin has been inserted and the block is not in alignment with the key-hole slot, the spring is prevented from causing the locking pin to exit from the through hole. In some embodiments, the invention may include safety indicators, such as color-coded markings on the locking pin or bracket, to signal whether the system is securely locked or disengaged.

In one aspect of the invention, a wall support rail and hanger apparatus is provided that comprises an elongated wall rail having an angled upper surface, said upper surface including a slot therein, the slot having a cross sectional shape in the form of an inverted T; a mounting bracket having a complementary angled lower surface adapted for engagement against the angled upper surface of the wall rail, the mounting bracket including at least one through hole therein extending from an upper surface of the mounting bracket to the lower angled surface thereof such that the through hole is in communication with said inverted T-slot when the angled surfaces of the wall rail and mounting bracket are engaged against each other; and a locking pin adapted for insertion into said through hole and into said inverted T-slot, the locking pin comprising: a shaft having a head at one end and a block at an opposite end, the block including at least one flange extending out perpendicularly from said shaft; wherein upon engagement of the angled surfaces of the mounting bracket and rail against each other, followed by insertion of said locking pin into said through hole and into said slot, rotation of said locking pin up to 90 degrees prevents said flange from being removed from said inverted T-slot preventing removal of said mounting bracket from said rail.

In variations of the above aspects of the invention, the through hole may have a cross sectional shape in the form of a key hole that corresponds to the cross sectional shape of the locking pin shaft and flange, such that said locking pin may only be inserted into or removed from said through hole when said shaft and flange are aligned with said key hole. In other variations, rotation of the locking pin frictionally engages said at least one flange against an inside wall of said inverted T-slot. In other variations, the mounting bracket further comprises a support bracket attached to the mounting bracket via fasteners; and the support bracket may selected from the group of: a hook, a shelf, a cantilevered arm, a slotted bracket, a magnetic retention surface, and combinations thereof.

In other variations, the locking pin further may comprise a spring provided along the shaft of said locking pin adjacent to said head for urging said head away from the upper surface of said mounting bracket; the head of the locking pin may comprise at least one tab extending out perpendicularly from said shaft; the tab on the head of the locking pin may be aligned with the at least one flange of the block, such that the position of the tab indicates the position of the at least one flange. In other variations, the locking pin may further comprise a visual alignment indicator configured to indicate when said locking pin is in a locked or unlocked configuration. In other variations, a detent may be provided in the inverted T-slot adjacent to the at least one through hole for engagement with said at least one flange to provide a tactile indication of the position of the at least one flange.

It is another aspect of the invention to include a tool mounting device that may include a mounting bracket having an angled mounting surface and a through hole. The device may further include a French cleat having an angled wedge surface configured to complement the angled mounting surface of the mounting bracket, where the French cleat may further include an inverted T-slot extending through the angled wedge surface. The tool mounting device may further include a locking pin having a shaft with a cap on one end, an engagement surface on an opposite end, and a flat surface adjacent to the engagement surface. The through hole of the mounting bracket may have a shape that is operable to align with the locking pin and engagement surface. The locking pin may be configured to be inserted through the aligned through hole into the inverted T-slot, wherein rotation of the locking pin may transition the locking pin between a locked configuration in which the engagement surface engages an interior wall of the T-slot to secure the mounting bracket in place, and an unlocked configuration in which the engagement surface aligns with the through hole to permit removal of the locking pin.

An additional aspect of the tool mounting device may further include a snap lock pin configured to secure the cap to the shaft. Embodiments of the mounting bracket may further include a tool receiver secured to the mounting bracket via fasteners. Embodiments of the tool receiver may include one or more of the following: shelves, cantilevered arms, integrated hooks, slotted brackets, adjustable arms, or magnetic retention surfaces. The French cleat may be secured to a wall using one or more fasteners. Embodiments of the locking pin may further include a spring-loaded mechanism that urges the locking pin to exit from the through hole. Embodiments of the cap of the locking pin may include a tactile marking or visual indicator to indicate whether the locking pin is in the locked or unlocked configuration. Embodiments of the locking pin may include a visual alignment indicator configured to indicate when the locking pin is in the locked configuration. Embodiments of the block of the locking pin and/or the inverted T-slot may include one or more detents in the surfaces that make frictional contact with each other to provide tactile indications of the locked or unlocked position of the locking pin. By way of example and without limitation, a detent may be provided on an upper surface of the inverted T-slot such that said at least one flange engages with the detent when the locking pin is rotated 90 degrees following insertion into the through hole.

It is another aspect of the present invention to provide a tool mounting system that may include a French cleat having an angled wedge surface and an inverted T-slot formed through the angled wedge surface. The system may further include one or more mounting brackets, each having an angled mounting surface complementary to the angled wedge surface of the French cleat, where the mounting brackets may further include one or more key-hole shaped through holes that align with the inverted T-slot when the bracket is engaged against the French cleat. Embodiments of the tool mounting system may include a locking pin having a shaft with a cap on one end, an engagement surface on an opposite end, and a flat surface adjacent to the engagement surface. The locking pin may be configured to secure the mounting bracket to the French cleat by rotating between a locked configuration in which the engagement surface engages an interior wall of the inverted T-slot to restrict movement of the mounting bracket, and an unlocked configuration in which the flat surface aligns with the key-hole shape of the through hole to permit removal of the locking pin.

Embodiments of the tool mounting system may further include a French cleat mounted to a vertical surface using one or more fasteners. Embodiments of the mounting bracket may further include a tool receiver secured by a plurality of fasteners. Embodiments of the tool receiver may include one or more of the following: shelves, cantilevered arms, integrated hooks, slotted brackets, adjustable arms, magnetic surfaces, and vibration-isolating pads. Embodiments of the locking pin may include a snap lock pin configured to secure the cap to the shaft. Embodiments of the locking pin may include a spring-loaded mechanism configured to automatically bias the locking pin into the locked configuration. Embodiments of the locking pin may include a textured grip surface on the cap to enhance user control during rotation between the locked configuration and the unlocked configuration. Embodiments of the mounting brackets may further include a retention feature configured to engage with a corresponding stop feature on the French cleat to limit movement of the mounting bracket along the French cleat.

It is another aspect of the present invention to provide a method of securing a mounting bracket to a French cleat. Embodiments of the method may include positioning the mounting bracket against the French cleat such that a through hole of the mounting bracket aligns with an inverted T-slot formed in an angled wedge surface of the French cleat. Embodiments of the method may further include aligning a locking pin with a key-hold shape of the through hole, and inserting the aligned locking pin into the through hole and inverted T-slot, where the locking pin may include a shaft with a cap on one end, an engagement surface on an opposite end, and a flat surface adjacent the engagement surface. Embodiments of the method may further include rotating the locking pin to engage the engagement surface with an interior wall of the inverted T-slot to secure the mounting bracket in a locked configuration. Embodiments of the method may further include rotating the locking pin to align the flat surface with the inverted T-slot and key-hole slot to transition the locking pin to an unlocked configuration for removal. Embodiments of the method may further include securing a tool receiver to the mounting bracket using one or more fasteners. Embodiments of the tool receiver may include one or more of the following: shelves, cantilevered arms, integrated hooks, slotted brackets, adjustable arms, or magnetic retention surfaces. Embodiments of the method may include installing the French cleat to a wall using a plurality of fasteners to ensure stable mounting. Embodiments of the method may include applying a visual alignment indicator on the locking pin, wherein the visual alignment indicator may be configured to indicate when the locking pin is in the locked configuration or the unlocked configuration.

Further aspects and embodiments will be apparent to those having skill in the art from the description and disclosure provided herein.

It is, therefore, an object of the present invention to provide methods and apparatus for temporarily securely mounting brackets for tools or other items, utilizing a modified French cleat with an inverted T-slot and a specially shaped locking pin and mechanism, enabling a user to position and temporarily engage a mounting bracket at a predefined location with high stability and precision.

It is also an object of the present invention to provide a wall rail and locking apparatus that ensures secure positioning of a mounting bracket while allowing for quick and precise engagement and disengagement, thereby improving ease of use and operational efficiency.

It is also an object of the present invention to provide an enhanced, versatile and durable tool mounting system by incorporating modular tool receivers, robust materials for strength and longevity, and optional features such as vibration isolation pads, magnetic retention surfaces, or adjustable brackets, ensuring compatibility with a wide range of tools and equipment across multiple mounting applications.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of an embodiment of a tool mounting apparatus of the present invention equipped with a tool and secured to a wall.

FIG. 2 provides a perspective view of an embodiment of a tool mounting apparatus of the present invention with a mounting member separated from the French cleat.

FIG. 3A provides a top view of an embodiment of a tool mounting apparatus of the present invention in a locked configuration.

FIG. 3B provides a cross-sectional side view of an embodiment of a tool mounting apparatus of the present invention along line 3B-3B of FIG. 3A.

FIG. 4A provides a top view of an embodiment of a tool mounting apparatus of the present invention in an unlocked configuration.

FIG. 4B provides a cross-sectional side view of an embodiment of a tool mounting apparatus of the present invention along line 4B-4B of FIG. 4A.

FIG. 5A provides a top view of an embodiment of a tool mounting apparatus of the present invention with support bracket in a locked configuration.

FIG. 5B provides a cross-sectional side view of an embodiment of a tool mounting apparatus of the present invention with support bracket along line 5B-5B of FIG. 5A.

FIG. 6A provides a top view of an embodiment of a tool mounting apparatus of the present invention with support bracket in an unlocked configuration.

FIG. 6B provides a cross-sectional side view of an embodiment of a tool mounting apparatus of the present invention with support bracket along line 6B-6B of FIG. 6A.

FIG. 7 provides an exploded perspective view of a locking pin of an embodiment of the present invention.

FIG. 8 provides a perspective view of an assembled locking pin of an embodiment of the present invention.

FIG. 9 provides a side view of a locking pin of an embodiment of the present invention.

FIG. 10 provides a perspective view of an embodiment of the present invention having a mounting member engaged against a French cleat with the locking pin removed from the through hole of the mounting member.

FIG. 11 provides a disengaged cross-sectional side view of a mounting member and French cleat of an embodiment of the present invention.

FIG. 12 provides a front view of a French cleat of an embodiment of the present invention.

FIG. 13 provides a side view of an embodiment of the present invention having a mounting member engaged against a French cleat with the locking pin removed from the through hole of the mounting member.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

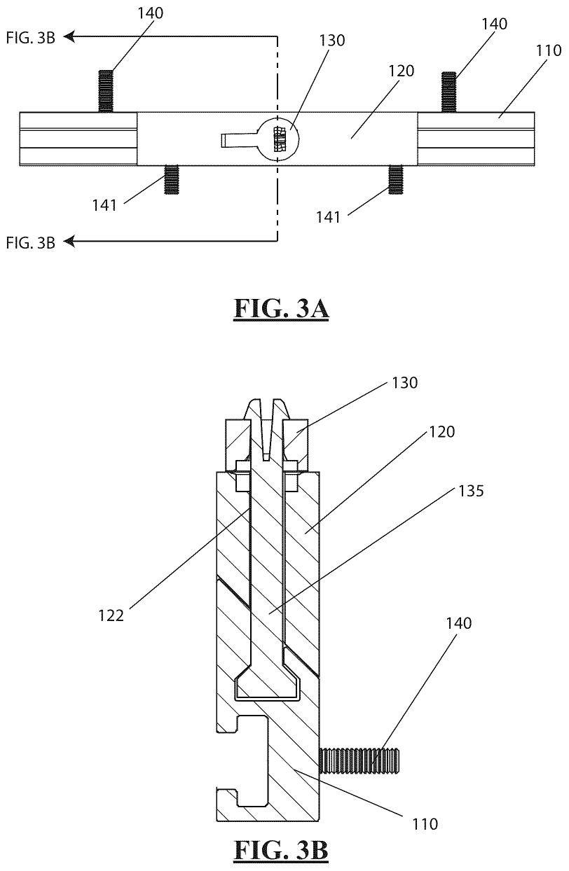

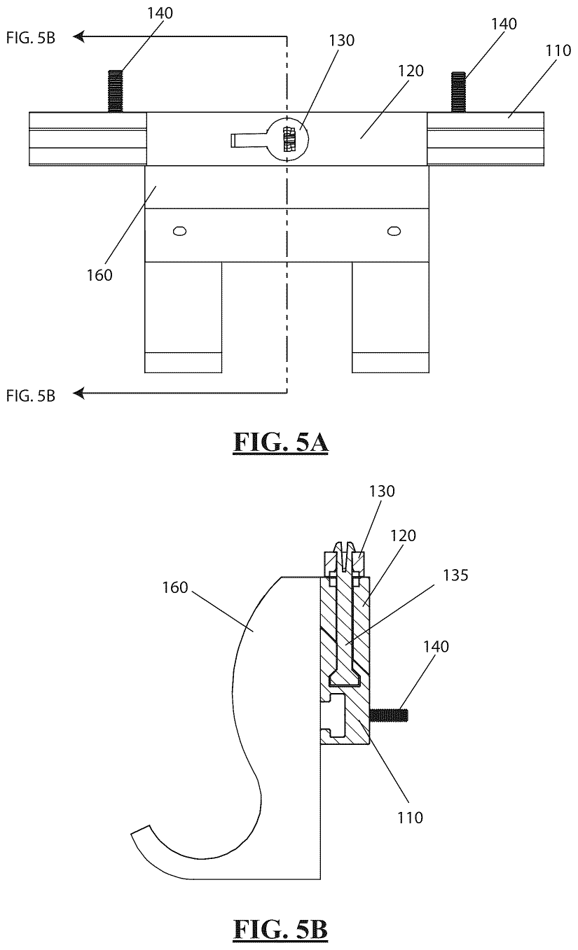

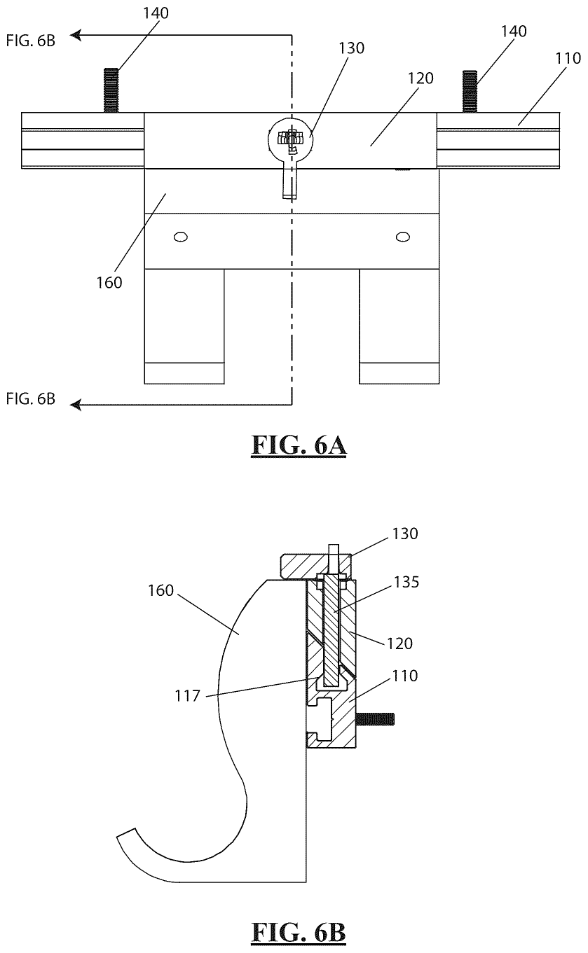

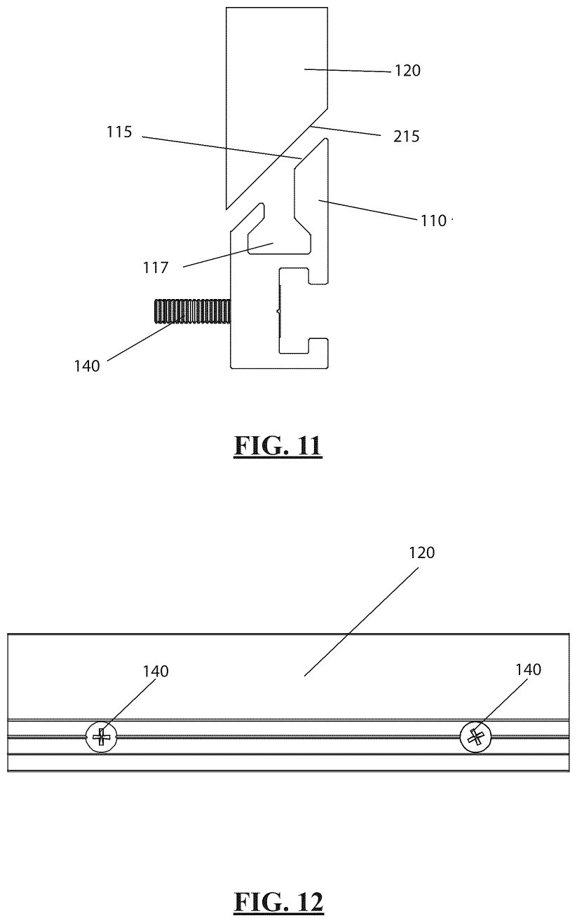

Referring to the drawings, wherein like reference characters designate like or corresponding parts throughout the several views, and referring particularly to FIGS. 6 and 11, it is seen that the illustrated embodiment of present invention provides a tool mounting and storage system 100 that includes an elongated wall rail having a modified French cleat 110 with an angled wedge surface 115 thereon, the rail having a longitudinal slot having a cross section in the shape of an inverted T (inverted T-slot) 117 extending from the angled surface 115. The inverted T-slot 117 may be configured to receive a locking pin 130 having 137 a block at a distal end thereof that selectively engages with the inverted T-slot 117 to secure a mounting bracket 120 to the French cleat 110. The mounting bracket 120 has a mounting surface 125 angled to complement the wedge surface 115 of the French cleat 110. The mounting bracket 120 further includes at least one through hole 122 that aligns with the T-slot 117 for receiving a locking pin 130 as shown in FIGS. 3 and 5.

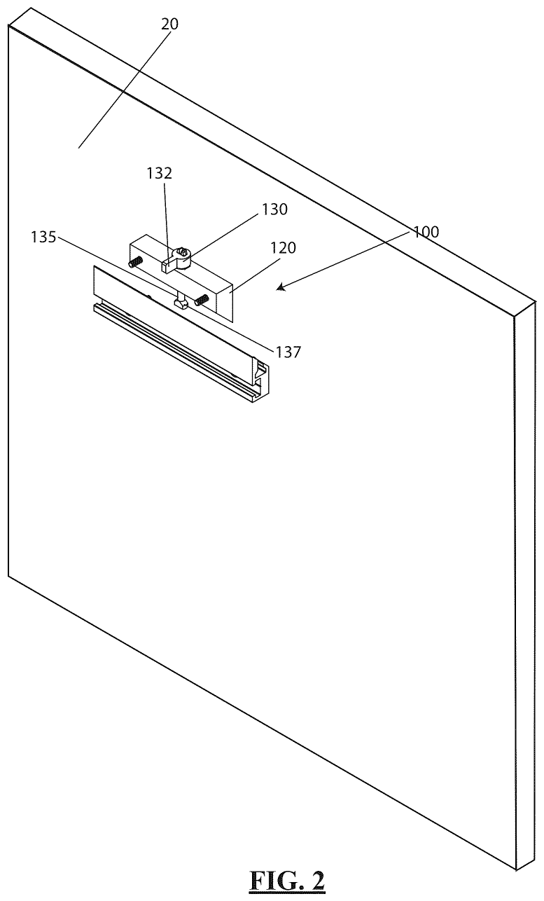

Embodiments of the locking pin 130 may include a shaft 135 having a head or cap 132 at a first or distal end, and a block 138 with one or more flanges or engagement surfaces 137 at the opposite distal end. The flanges or engagement surfaces 137 extend out perpendicularly from one side or from opposite sides of the distal end 138 of the shaft. Each through hole 122 has a cross section that is sized and shaped to match that of the shaft 135 with block structure 138 and flanges/engagement surfaces 137. This cross section may be in the form of a modified key-hole 123, such that the shaft 135 and block structure 138 may only be received into or removed from the through hole 122 when the engagement structures 137 of the block are properly oriented to align with the modified key-hole shape 123, as shown in FIG. 10. The head 132 of the shaft 135 may be provided with a cap, tab, wing, knob, extension or other structure 132 that prevents the head 132 from entering slot 123, as shown in FIG. 2.

In some embodiments, when assembled, the mounting bracket 120 may be positioned against the French cleat 110 such that the through hole 122 aligns with the inverted T-slot 117 opening. An embodiment of a locking pin 130 may be aligned with the key-hole opening 123 of the through hole 122, and inserted through the aligned openings, with its flat surface 138 facilitating passage through the inverted T-slot, as shown in FIG. 6. Once fully inserted, the pin may be rotated or otherwise actuated, causing the engagement surface 137 to engage with a wall of the inverted T-slot 117 as shown in FIG. 3, thereby locking the mounting bracket 120 in place. The locking system ensures that the mounting bracket 120 remains temporarily but securely attached to the French cleat 110, preventing unintended movement or detachment, until the locking pin 130 is once again rotated into alignment with the key-hole opening and removed. The system is particularly useful for securing tools, storage units, and other mounted objects that require a fixed orientation and robust support.

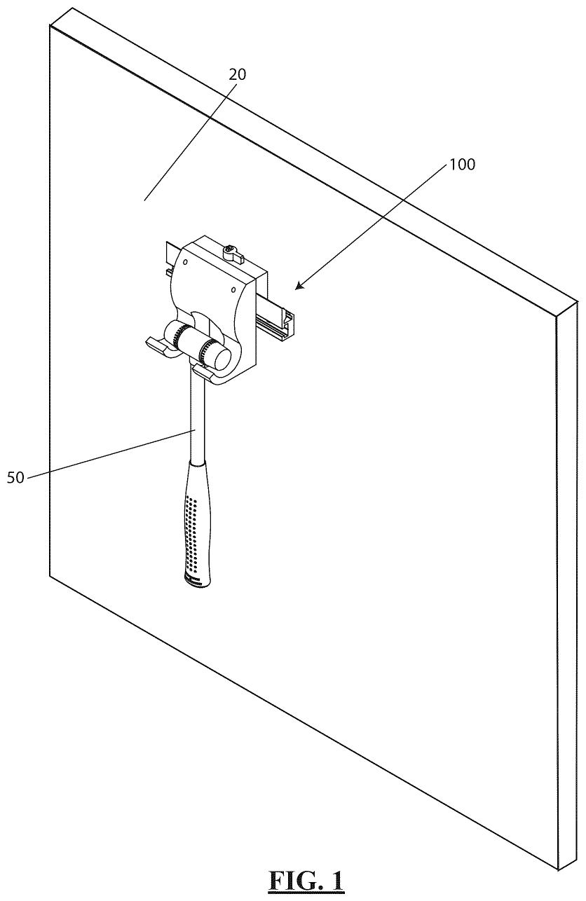

FIG. 1 illustrates an embodiment of a tool mounting apparatus of the present invention 100, which includes a French cleat 110 secured to a wall, a mounting bracket 120 that engages with the French cleat, and a locking pin 130 that secures the bracket in place. The illustrated French cleat 110 includes an angled wedge surface 115 that complements the angled mounting surface 125 of the mounting bracket 120, ensuring stable engagement when assembled. An inverted T-slot 117 is formed along the angled wedge surface 115 to receive the locking pin 130. The mounting bracket 120 includes a through hole 122 that aligns with the inverted T-slot 117 when the bracket is positioned on the French cleat 110, thereby providing an access point for the locking pin 130. The mounting bracket 120 may support a tool receiver 160 that is configured to support a tool 50.

As shown in FIGS. 2 and 3, when the illustrated tool mounting system 100 is in its locked configuration, the locking pin 130 is fully inserted through the aligned openings of the inverted T-slot 117 and key-hole opening 123 in the through hole 122. The locking pin 130 includes an engagement surface 137 configured to interface with the inverted T-slot 117 to secure the mounting bracket 120 in place. The engagement surface 137 may be angled or tapered to press against the interior wall of the inverted T-slot 117, creating a secure mechanical lock that resists movement as shown in FIG. 3. Additionally, embodiment of the locking pin 130 may include a flat surface 138 that permits free movement of the pin through the key-hole opening 123 and inverted T-slot 117 when aligned. By rotating or otherwise actuating the locking pin 130 (e.g., by rotating head 132), an engagement surface 137 is brought into contact with the inverted T-slot wall, securing the mounting bracket 120 is retained in a fixed position.

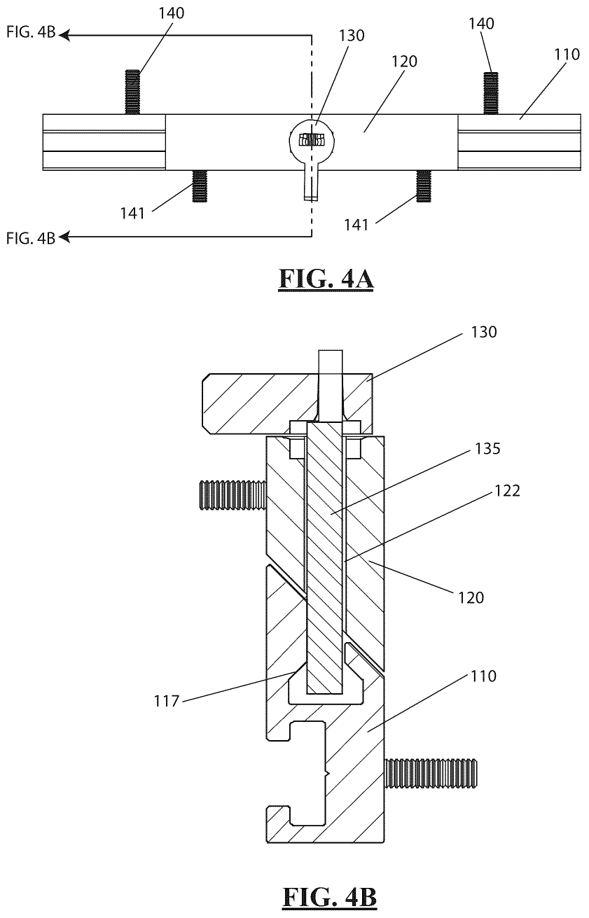

In its unlocked configuration, as shown inn the illustrated embodiment of FIGS. 4 and 5, the locking pin 130 is rotated such that the engagement surface 138 aligns with the inverted T-slot 117 and key-hole opening 123, enabling the locking pin to slide freely for insertion or removal. This disengagement allows the mounting bracket 120 to be separated from the French cleat 110 without resistance. The complementary engagement between the angled mounting surface 125 and the angled wedge surface 115 of the French cleat 110 provides passive stability even when the system is in its unlocked state. This passive stability feature ensures the mounting bracket 120 does not dislodge accidentally before intentional removal. The locking pin 130's rotational functionality allows the system to toggle efficiently between locked and unlocked states, ensuring a secure yet easily operable mounting solution.

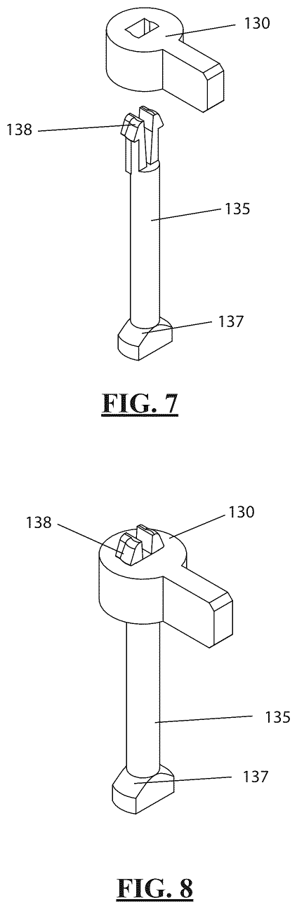

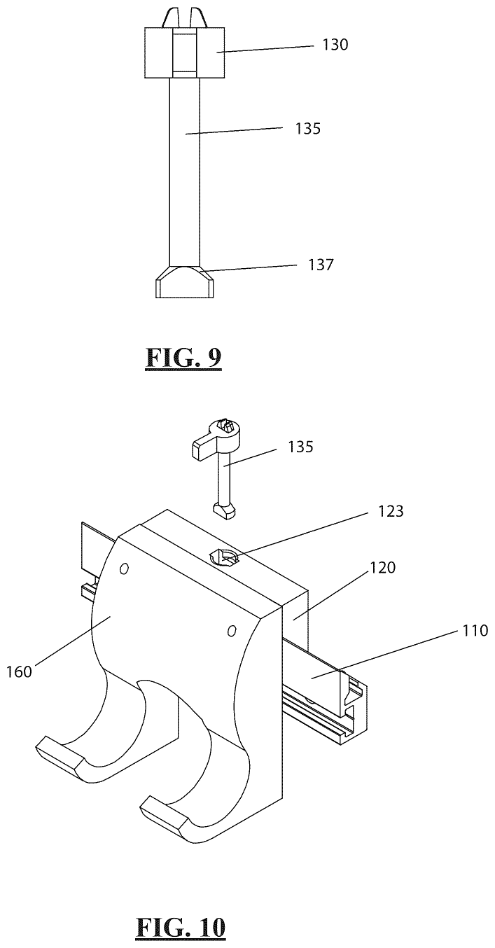

FIGS. 7 and 8 illustrate an embodiment of a locking pin 130 of the present invention. This embodiment includes a shaft 135 having a lower block 138 with a an engagement surface or flanges 137 at the distal end, and head at the opposite end. The illustrated embodiment, shows a snap lock 139 (e.g., push-in fastener), although any suitable head or cap structure may be used, so long as it is larger than the key-hole opening 123 in the through hole (see FIG. 10). The illustrated snap lock 139 is operable to secure a cap 132 to the shaft 135 via an opening 131. This snap lock 139 mechanism provides a stable and secure connection that resists unintentional disassembly while allowing for simple removal if necessary.

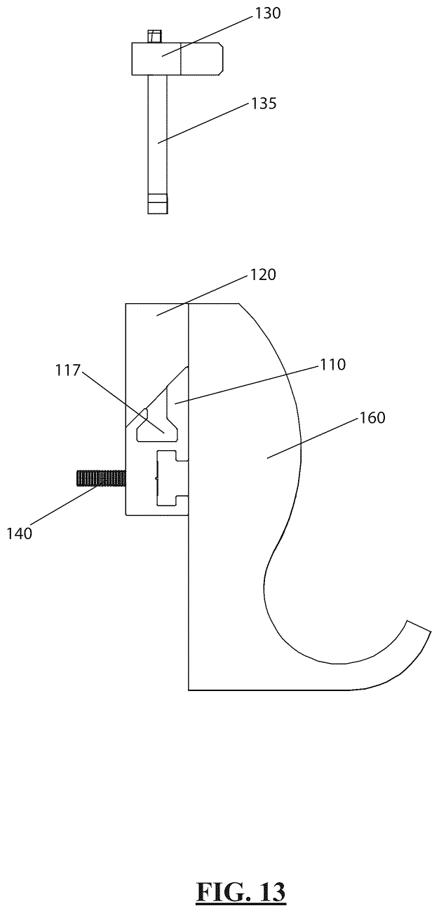

As shown in FIGS. 3 and 10, in some embodiments, the mounting bracket 120 may include a tool receiver 160 that is secured using a pair of fasteners 141 and may be positioned on the French cleat 110. In some embodiments, the locking pin cap 132 may include a visual indicator to show when the locking pin is in the locked position. The locking pin 130 may then be inserted through the aligned through hole 122 to secure the mounting bracket 120 in place, as shown in FIGS. 10 and 13. As further shown in FIGS. 11 and 12, the French cleat 110 may be secured to a wall using a pair of fasteners 140 to ensure robust and stable attachment.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A wall support rail and hanger apparatus comprising:
a. an elongated rail having an angled upper surface, said upper surface including a slot therein, the slot having a cross sectional shape in the form of an inverted T and having an interior wall;
b. a mounting bracket having a complementary angled lower surface adapted for engagement against the angled upper surface of the rail, the mounting bracket including at least one through hole therein extending from an upper surface of the mounting bracket to the lower angled surface thereof such that the through hole is in communication with said inverted T-slot when the angled surfaces of the rail and mounting bracket are engaged against each other; and
c. a locking pin pin comprising: a shaft having a head at one end and a block at an opposite end, the block including at least one flange extending out perpendicularly from said shaft, said shaft, block and at least one flange being adapted for insertion into said at least one through hole and into said inverted T-slot;
wherein upon engagement of the angled surfaces of the mounting bracket and rail against each other, followed by insertion of said shaft, block and at least one flange into said at least one through hole and into said inverted T-slot, rotation of said locking pin up to 90 degrees engages said at least one flange with the interior wall of said inverted T-slot and prevents said at least one flange from being removed from said inverted T-slot preventing removal of said mounting bracket from said rail.

2. The apparatus of claim 1, wherein said through hole has a cross sectional shape in the form of a key hole that corresponds to the cross sectional shape of the locking pin shaft and flange, such that said locking pin may only be inserted into or removed from said through hole when said shaft and flange are aligned with said key hole.

3. (canceled)

4. The apparatus of claim 1, wherein said mounting bracket further comprises a support bracket attached to said mounting bracket via fasteners.

5. The apparatus of claim 4, wherein said support bracket is selected from the group of: a hook, a shelf, a cantilevered arm, a slotted bracket, a magnetic retention surface, and combinations thereof.

6. The apparatus of claim 1, wherein said locking pin further comprises a spring provided along the shaft of said locking pin adjacent to said head for urging said head away from the upper surface of said mounting bracket.

7. The apparatus of claim 1, wherein the head of said locking pin comprises at least one tab extending out perpendicularly from said shaft.

8. The apparatus of claim 7, wherein the tab on the head of said locking pin is aligned with the at least one flange of said block, such that the position of the tab indicates the position of the at least one flange.

9. The apparatus of claim 1, wherein said locking pin further comprises a visual alignment indicator configured to indicate when said locking pin is in a locked or unlocked configuration.

10. The apparatus of claim 1, wherein a detent is provided in said inverted T-slot adjacent to said at least one through hole for engagement with said at least one flange to provide a tactile indication of the position of the at least one flange.

11. A tool mounting apparatus comprising:
a. a French cleat having an angled upper surface and an inverted T-slot in communication with said angled surface;
b. a mounting bracket having an angled mounting surface that is complementary to the angled surface of said French cleat, said mounting bracket further comprising a through hole aligned with said inverted T-slot when said mounting bracket is engaged with said French cleat; and
c. a locking pin comprising:
i. a shaft,
ii. a cap at one end of the shaft,
iii. an engagement surface at an opposite end of the shaft, and
iv. a flat surface adjacent to said engagement surface;
wherein said locking pin is configured to secure said mounting bracket to said French cleat by rotating between a locked configuration in which said engagement surface engages an interior wall of said inverted T-slot to restrict movement of said mounting bracket, and an unlocked configuration in which said flat surface aligns with said inverted T-slot to permit removal of said locking pin.

12. The apparatus of claim 11, wherein said mounting bracket further comprises a tool receiver secured to said mounting bracket by at least one fastener.

13. The apparatus of claim 12, wherein said tool receiver is selected from the group of integrated hooks, slotted brackets, adjustable arms, magnetic surfaces, vibration-isolating pads, and combinations thereof.

14. The apparatus of claim 11, wherein said locking pin includes a spring configured to urge said locking away from said through hole.

15. A method of securing a mounting bracket to a French cleat, said method comprising:
a. positioning said mounting bracket against said French cleat such that a through hole of said mounting bracket aligns with an inverted T-slot in an angled surface of said French cleat;
b. inserting a locking pin into said aligned through hole and said T-slot, said locking pin having a shaft with a cap on one end, an engagement surface at an opposite end, and a flat surface adjacent said engagement surface; and
c. rotating said locking pin to engage said engagement surface with an interior wall of said inverted T-slot to secure said mounting bracket against said French cleat in a locked configuration.

16. The method of claim 15, further comprising rotating said locking pin to align said flat surface with said T-slot to transition said locking pin to an unlocked configuration for removal.

17. The method of claim 15, further comprising a tool receiver attached to said mounting bracket.

18. The method of claim 17, wherein said tool receiver is selected from the group of: integrated hooks, slotted brackets, adjustable arms, magnetic retention surfaces, and combinations thereof.

19. The method of claim 15, wherein a visual alignment indicator is provided on said locking pin that is configured to indicate when said locking pin is in said locked configuration or in an unlocked configuration.

20. The method of claim 15, wherein said through hole has a cross sectional shape in the form of a key hole that corresponds to the cross sectional shape of the shaft, engagement surface and flat surface of said locking pin, such that said locking pin may only be inserted into or removed from said through hole when said shaft, engagement surface and flat surface are aligned with said key hole.

21. The tool mounting apparatus of claim 11, wherein said through hole has a cross sectional shape in the form of a key hole that corresponds to the cross sectional shape of the shaft, engagement surface and flat surface of said locking pin, such that said locking pin may only be inserted into or removed from said through hole when said shaft, engagement surface and flat surface are aligned with said key hole.
